(19) United States
(12) Patent Application Publication
(10) Pub. No.: US 2013/0207994 A1
(43) Pub. Date: Aug. 15, 2013

(54) System and method for generating and applying a color theme to a user interface

(71) Applicants: Vilen Rodeski, San Francisco, CA (US); Brian Strong, San Jose, CA (US); Don Macaskill, Los Altos, CA (US)

(72) Inventors: Vilen Rodeski, San Francisco, CA (US); Brian Strong, San Jose, CA (US); Don Macaskill, Los Altos, CA (US)

(21) Appl. No.: 13/385,311

(22) Filed: Feb. 13, 2012

(51) Int. Cl. G09G 5/02

(52) U.S. Cl. 345/594; 345/593

(57) ABSTRACT

A method for applying a color scheme to a user interface that includes one or more user interface (UI) elements. The method includes receiving a selection of a first color, generating a first portion of a color palette that includes the first color and one or more colors that sequentially transition from the first color to a first termination color, and assigning a color from the color palette to a UI element included in the user interface, wherein the color from the color palette corresponds to a position in the color palette associated with the UI element.

### BACKGROUND

1. Field of the Invention

The present invention relates to the field of computer software and, in particular, to a system and method for generating and applying a color theme to a user interface.

2. Description of the Related Art

In recent years, the popularity of personal web pages that are hosted by web service providers has increased. Examples of such personal web pages include profile pages in social networks, personal blog pages, personal photo galleries, and the like. There exists a strong connection between a user and their personal web page that has led web service providers to enable their users to customize the look and feel of personal web pages. For example, some web service providers allow users to upload photos that are displayed as background images on their personal web pages, and/or allow users to edit the font size and font type displayed in their personal web pages. Some web service providers also enable users to modify the colors of user interface (UI) elements that are included in the personal web page, such as font colors, border colors, and the like.

One popular approach of modifying the colors of UI elements involves the user manually selecting one or more user interface element (UI) elements, such as a hypertext markup language (HTML) button, and then selecting a color to be applied to the UI element. However, a large number of UI elements are typically included in even the simplest of personal web pages; therefore, the manual selection process quickly becomes cumbersome. Moreover, a majority of individuals do not understand the complex relationship between colors and what is pleasing to the human eye, which results in the users conducting a trial-and-error process that further contributes to the burdensome task of customizing a personal web page.

As the foregoing illustrates, there is a need in the art for an improved technique for modifying the appearance of user interfaces, such as personal web pages.

### SUMMARY

Embodiments of the invention provide a software application through which a user may customize, via a selection of a single color, the color for one or more user interface (UI) elements included in a graphical user interface (GUI). The user selects a color via a color selection UI. A color palette that includes a range of colors is generated based on the single color. UI elements in the GUI are each associated with a shade number that corresponds to a particular location in the color palette. The software application can assign colors to the UI elements based on the generated color palette.

One embodiment provides a method for applying a color scheme to a user interface that includes one or more user interface (UI) elements. The method includes receiving a selection of a first color, generating a first portion of a color palette that includes the first color and one or more colors that sequentially transition from the first color to a first termination color, and assigning a color from the color palette to a UI element included in the user interface, wherein the color from the color palette corresponds to a position in the color palette associated with the UI element.

Further embodiments provide a non-transitory computer-readable medium and a computer system to carry out the method set forth above.

### BRIEF DESCRIPTION OF THE DRAWINGS

The patent or application file contains at least one drawing executed in color. Copies of this patent or patent application publication with color drawing(s) will be provided to the Office upon request and payment of the necessary fee.

FIG. 1 illustrates a networked computer environment in which embodiments of the invention may be practiced.

FIG. 2 depicts one architecture of a computer system within which embodiments of the present invention may be implemented.

FIGS. 3A-3H are conceptual diagrams of applying a color scheme to a user interface, according to embodiments of the invention.

FIG. 4 is a flow diagram of method steps for applying a color scheme to a user interface, according to one embodiment of the invention.

### DETAILED DESCRIPTION

In the following description, several specific details are presented to provide a thorough understanding of embodiments of the invention. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

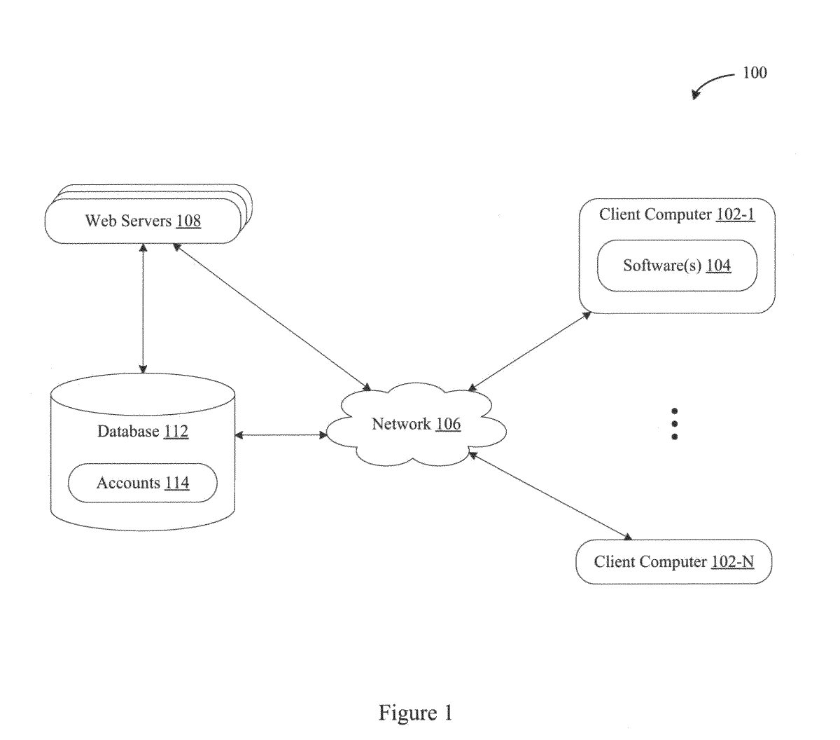

FIG. 1 illustrates a networked computer environment 100 in which embodiments of the invention may be practiced. As shown, the networked computer environment 100 includes a plurality of client computers 102 (only two of which are shown) and a plurality of web servers 108 that are in communication with database 112, which stores accounts 114. The web servers 108 communicate with the database 112 via a local connection (e.g., a Storage Area Network (SAN) or Network Attached Storage (NAS)) or over the Internet (e.g., a cloud-based storage service). The web servers 108 are configured to either directly access data included in the database 112 or to interface with a database manager that is configured to manage data included within the database 112. An account 114 is a data object that stores data associated with a user, such as the user's email address, password, contact information, billing information, color scheme(s) for his or her personal web page(s), and the like. The client computers 102 and the web server computers 108 are connected over a computer network 106, e.g., the Internet.

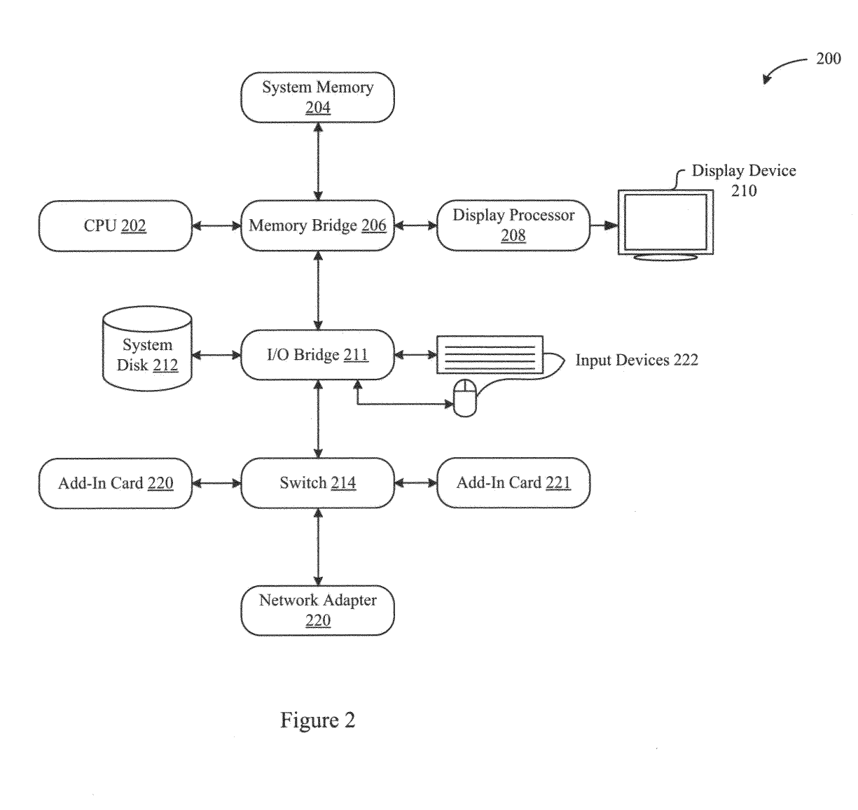

Each client computer 102 includes conventional components of a computing device, e.g., a processor, system memory, a hard disk drive, input devices such as a mouse and a keyboard, and output devices such as a monitor, which are illustrated in FIG. 2. Each web server 108 includes a processor and a system memory (not shown), and manages the content stored in database 112 using, e.g., a relational database software. Web servers 108 are programmed to communicate with one another and are also programmed to communicate with client computers 102 using a network protocol, for example, the TCP/IP protocol. The client computers 102 are programmed to execute software(s) 104, such as web browser programs and other software applications, and access web pages and/or applications managed by web servers 108 by specifying a uniform resource locator (URL) that directs to web servers 108.

In the embodiments of the present invention described below, users are respectively operating the client computers 102 that are connected to the web servers 108 over the network 106. Web pages are displayed to a user via the client computers 102. The web pages are transmitted from the web servers 108 to the user's client computer 102 and processed by the web browser program stored in that user's client computer 102 for display through a display device in communication with that user's client computer 102.

FIG. 2 depicts one architecture of a computer system 200 within which embodiments of the present invention may be implemented. Specifically, computer system 200 is representative of a configuration that may be implemented by web servers 108 and/or client computers 102. Computer system 200 may be a computer workstation, personal computer, video game console, personal digital assistant, rendering engine, or any other device suitable for practicing one or more embodiments of the present invention.

As shown, computer system 200 includes a central processing unit (CPU) 202 and a system memory 204 communicating via a bus path that may include a memory bridge 206. CPU 202 includes one or more processing cores, and, in operation, CPU 202 is the master processor of system 200, controlling and coordinating operations of other system components. System memory 204 stores software applications and data for use by CPU 202. CPU 202 runs software applications and optionally an operating system. Memory bridge 206, which may be, e.g., a Northbridge chip, is connected via a bus or other communication path (e.g., a HyperTransport link) to an I/O (input/output) bridge 211. I/O bridge 211, which may be, e.g., a Southbridge chip, receives user input from one or more user input devices 222 (e.g., keyboard, mouse, joystick, digitizer tablets, touch pads, touch screens, still or video cameras, motion sensors, and/or microphones) and forwards the input to CPU 202 via memory bridge 206.

A display processor 208 is coupled to memory bridge 206 via a bus or other communication path (e.g., a PCI Express, Accelerated Graphics Port, or HyperTransport link); in one embodiment display processor 208 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 204.

Display processor 208 periodically delivers pixels to a display device 210 (e.g., a screen or conventional CRT, plasma, OLED, SED or LCD based monitor or television). Additionally, display processor 208 may output pixels to film recorders adapted to reproduce computer generated images on photographic film. Display processor 208 can provide display device 210 with an analog or digital signal.

A system disk 212 is also connected to I/O bridge 211 and may be configured to store content and applications and data for use by CPU 202 and display processor 208. System disk 212 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 214 provides connections between I/O bridge 211 and other components such as a network adapter 220 and various add-in cards 220 and 221. Network adapter 220 allows system 200 to communicate with other systems via an electronic communications network, and may include wired or wireless communication over local area networks and wide area networks such as the Internet.

Other components (not shown), including USB or other port connections, film recording devices, and the like, may also be connected to I/O bridge 211. For example, an audio processor may be used to generate analog or digital audio output from instructions and/or data provided by CPU 202, system memory 204, or system disk 212. Communication paths interconnecting the various components in FIG. 2 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 208 incorporates circuitry optimized for graphics and video processing, including, for example, video output circuitry, and constitutes a graphics processing unit (GPU). In another embodiment, display processor 208 incorporates circuitry optimized for general purpose processing. In yet another embodiment, display processor 208 may be integrated with one or more other system elements, such as the memory bridge 206, CPU 202, and I/O bridge 211 to form a system on chip (SoC). In still further embodiments, display processor 208 is omitted and software executed by CPU 202 performs the functions of display processor 208.

Pixel data can be provided to display processor 208 directly from CPU 202. In some embodiments of the present invention, instructions and/or data representing a scene are provided to a render farm or a set of server computers, each similar to system 200, via network adapter 220 or system disk 212. The render farm generates one or more rendered images of the scene using the provided instructions and/or data. These rendered images may be stored on computer-readable media in a digital format and optionally returned to system 200 for display. Similarly, stereo image pairs processed by display processor 208 may be output to other systems for display, stored in system disk 212, or stored on computer-readable media in a digital format.

Alternatively, CPU 202 provides display processor 208 with data and/or instructions defining the desired output images, from which display processor 208 generates the pixel data of one or more output images, including characterizing and/or adjusting the offset between stereo image pairs. The data and/or instructions defining the desired output images can be stored in system memory 204 or graphics memory within display processor 208. In an embodiment, display processor 208 includes 3D rendering capabilities for generating pixel data for output images from instructions and data defining the geometry, lighting shading, texturing, motion, and/or camera parameters for a scene. Display processor 208 can further include one or more programmable execution units capable of executing shader programs, tone mapping programs, and the like.

It will be appreciated that the system shown herein is illustrative and that variations and modifications are possible. The connection topology, including the number and arrangement of bridges, may be modified as desired. For instance, in some embodiments, system memory 204 is connected to CPU 202 directly rather than through a bridge, and other devices communicate with system memory 204 via memory bridge 206 and CPU 202. In other alternative topologies display processor 208 is connected to I/O bridge 211 or directly to CPU 202, rather than to memory bridge 206. In still other embodiments, I/O bridge 211 and memory bridge 206 might be integrated into a single chip. The particular components shown herein are optional; for instance, any number of add-in cards or peripheral devices might be supported. In some embodiments, switch 214 is eliminated, and network adapter 220 and add-in cards 220, 221 connect directly to I/O bridge 211.

Network computers are another type of computer system that can be used in conjunction with the teachings provided herein. Network computers do not usually include a hard disk or other mass storage, and the executable programs are loaded from a network connection into the memory 204 for execution by the CPU 202. A Web TV system, which is known in the art, is also considered to be a computer system, but it may lack some of the features shown in FIG. 2, such as certain input or output devices. A typical computer system will usually include at least a processor, memory, and a bus coupling the memory to the processor. In some embodiments, the system 200 may include one or more CPUs 202, one or more display processors 208, and/or one or more of any of the system elements included in FIG. 2.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description above. In addition, the present examples are not described with reference to any particular programming language, and various examples may thus be implemented using a variety of programming languages.

As described in greater detail herein, embodiments of the invention provide a software application through which a user may customize, via a selection of a single color, the color for one or more user interface (UI) elements included in a graphical user interface (GUI). In particular, a color selection UI is presented to the user, e.g., a color wheel or color picker, from which the user selects the single color. Once the single color is selected, one or more termination colors, which represent end points of color difference from the selected color, are generated, or user-selected. From the selected color, and termination color(s), one or more color palettes, having distinct colors within the range from the selected color to the termination color(s), are generated. In embodiments that include multiple color palettes, each color palette corresponds to a different type of UI element. For example, a first color palette may be associated with typography UI elements and a second color palette may be associated with background UI elements. In embodiments that include two termination colors, each color palette includes both a first shade associated with a first termination color—which is the color white or a user-selected termination color—and a second shade associated with a second termination color—which is the color black or a user-selected termination color. Other shades in the generated palette are associated with colors between the first termination color and the second termination color, although each of the other shades can be manually reassigned to another color by the user if he or she so desires. Finally, for each UI element included in the GUI, the software application associates the UI element with a corresponding color in one of the one or more color palettes. The correspondence of the UI element to a color in one of the one or more color palettes is based on a pre-determined mapping or based on a manual assignment from the user.

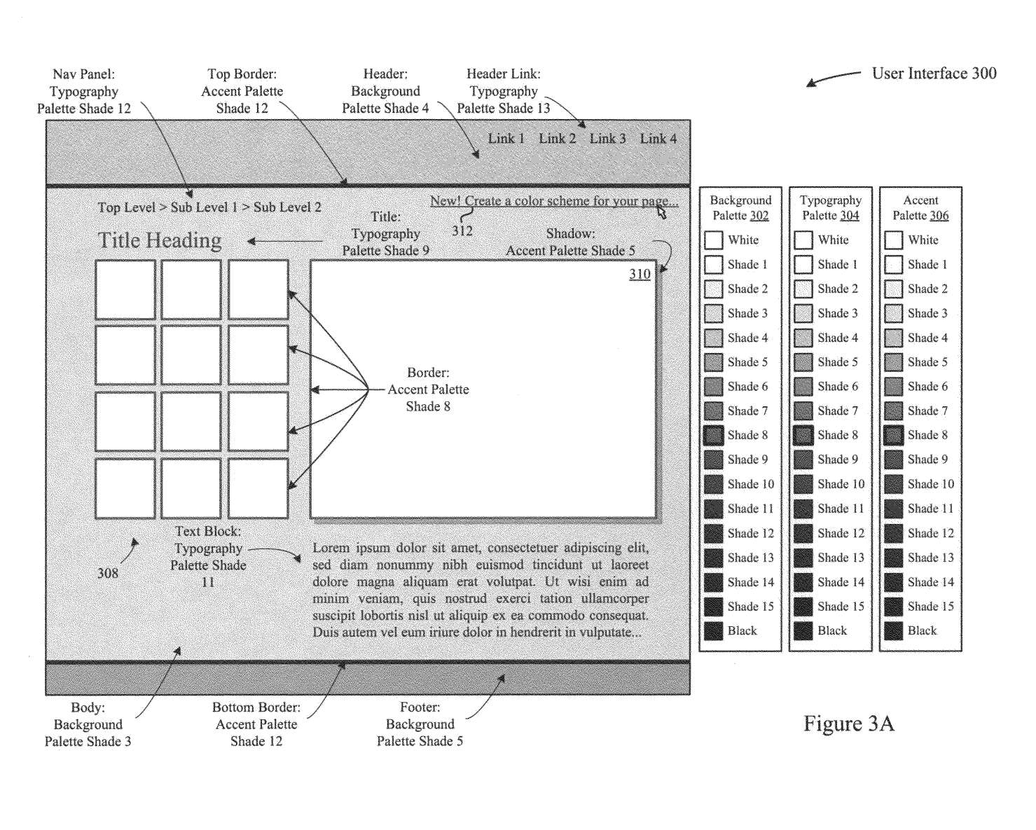

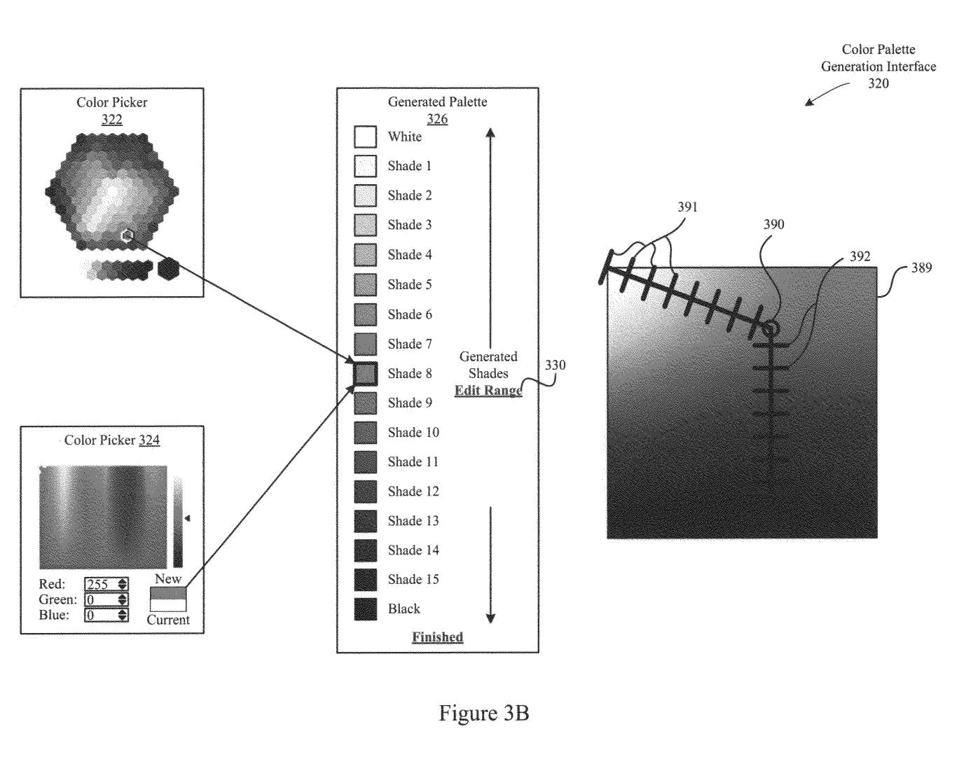

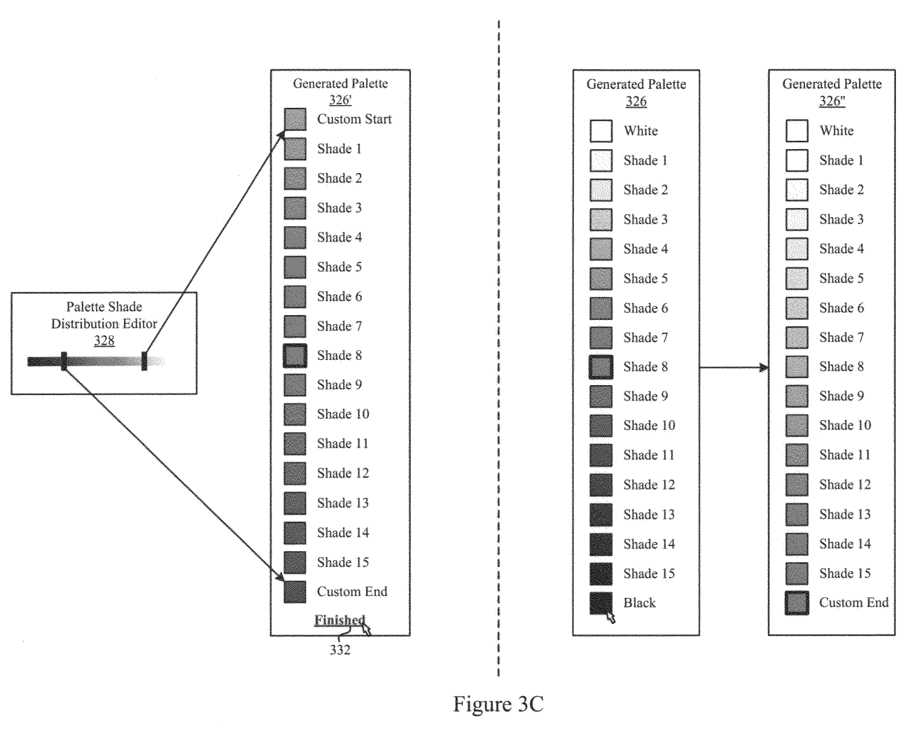

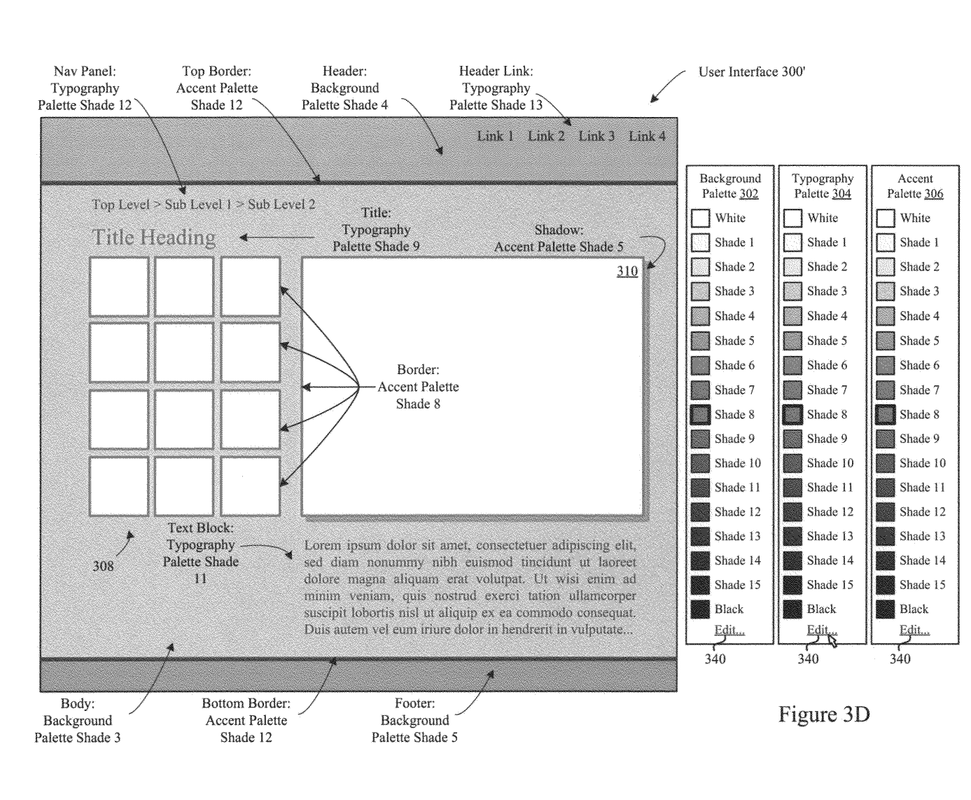

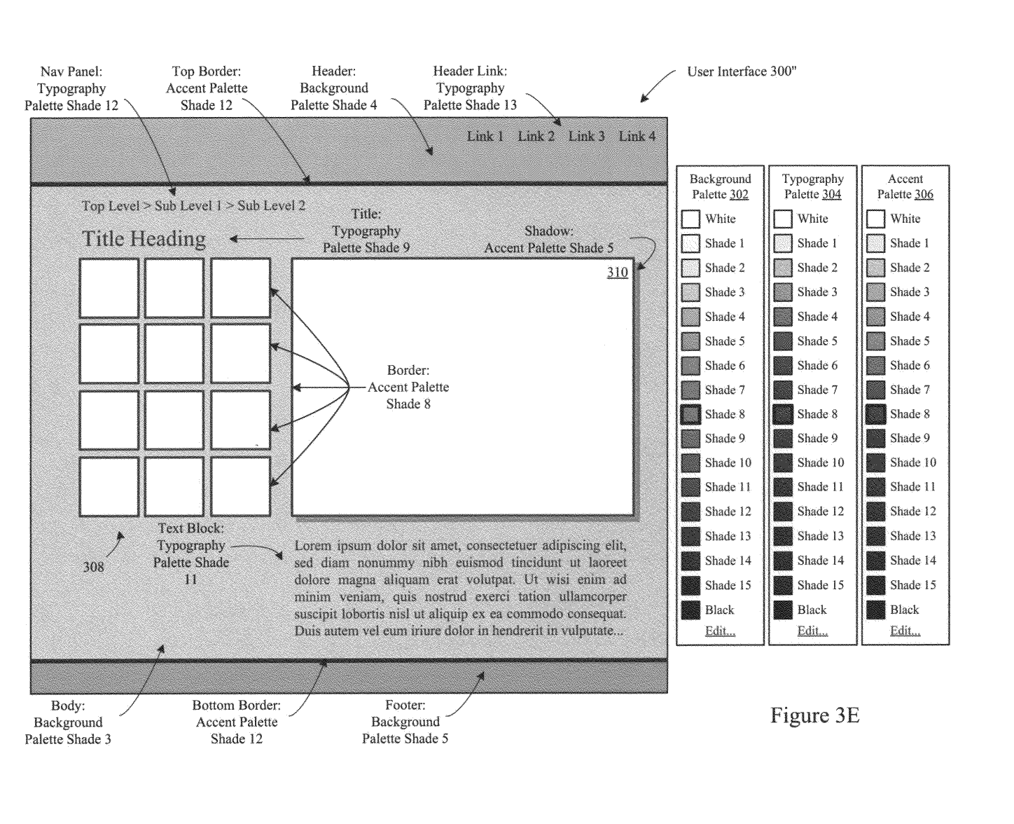

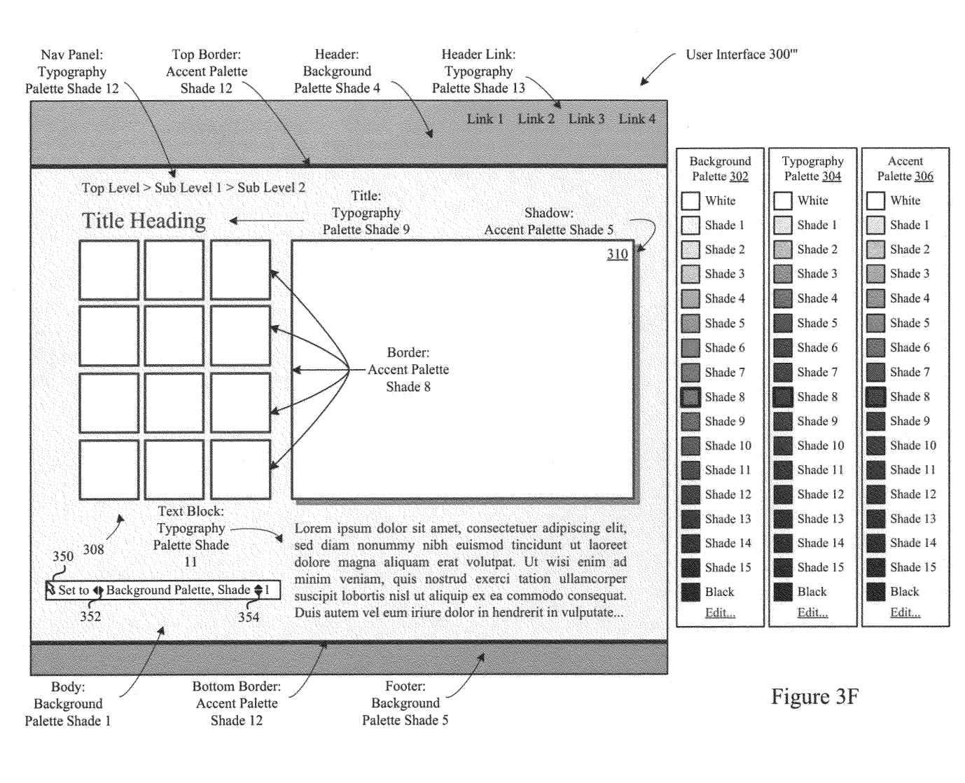

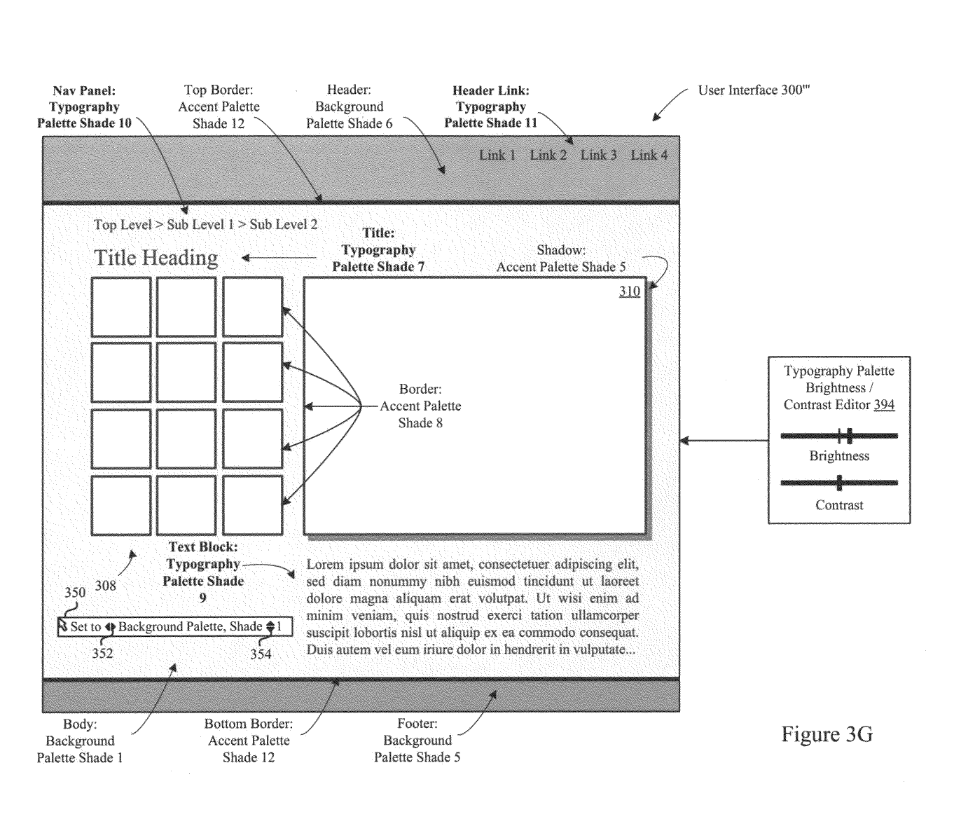

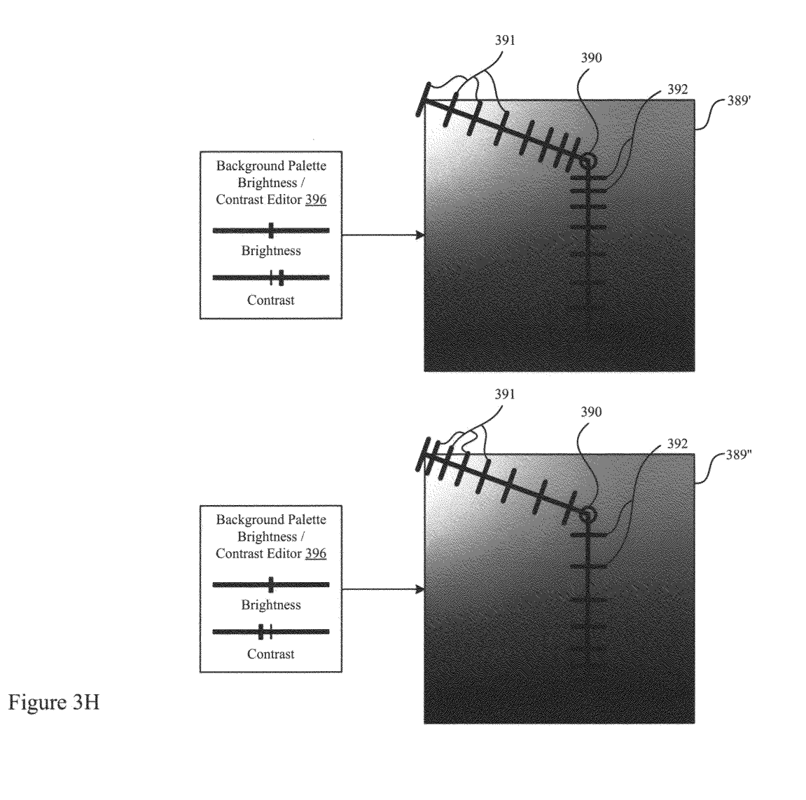

FIGS. 3A-3H are conceptual diagrams of applying a color scheme to a user interface 300, according to embodiments of the invention. The user interface 300 illustrated in FIGS. 3A-3H is accessible via a web browser application (not illustrated) and includes a plurality of web-based (UI) elements, e.g., a header, a footer, a body, borders, links, text blocks and the like, which are arranged to present a photo gallery web page within the web browser application. For example, user interface 300 includes a grid of thumbnails 308 on the left side and a main window 310 on the right side that is configured to display an enlarged view of any thumbnail that is selected by a user interacting with user interface 300. For example, the user interface 300 can be displayed to a user who is viewing a friend's photos via the photo gallery web page.

In the particular example illustrated in FIG. 3A, each of the UI elements included in user interface 300 is associated with a specific shade of color included in one of three palettes 302, 304 and 306. Specifically, user interface 300 is associated with a background palette 302, a typography palette 304, and an accent palette 306. Each of the three palettes 302, 304 and 306 corresponds to a different group of UI elements included within the user interface 300. For example, the background palette 302 is associated with UI elements such as background of the header, background of the footer, the body of the page, etc., the typography palette 304 is associated with text, such as headings, links, etc., and the accent palette 306 is associated with border, shading, shadows, etc. As shown, each palette includes seventeen separate and distinct colors, fifteen of which are derived from shade 8 and two termination colors (i.e., white and black). However, in other embodiments, any number of distinct colors can be included in the palette. The border of shade 8 is bolded within each of the palettes 302, 304 and 306 to provide emphasis. In one embodiment, shade 8 is the color that was initially selected by the user as the single color from which the other colors in the palette are derived.

In one embodiment, each palette also includes, at least by default, white and black colors as first and second termination colors, respectively. In other embodiments, other colors besides white and black are the first and second termination colors, as described in detail below in conjunction with FIG. 3C. In the example illustrated in FIG. 3A, each of the background palette 302, typography palette 304 and accent palette 306 are derived from the same shade 8, which has a Red/Green/Blue (RGB) value of (127,127,127)—i.e., a grey color that is halfway between white (RGB value of (255,255,255)) and black (RGB value of (0,0,0)).

As described above, a user can select a color for shade 8. For example, the user can select the color for shade 8 by typing in a color number (e.g., hexadecimal color value), selecting the color from a color palette or color wheel, or via any other technique. The shades that lie above shade 8 (shades 1 to 7 and white) represent eight different steps of equally-increasing the RGB value(s) until the RGB value(s) of white (i.e., 255, 255, 255) is reached. In this example, the upper eight different shades are calculated by adding multiples of “16” to each R, G, and B value of shade 8, where the value of “16” is derived from dividing by eight (different shades) the difference between the RGB value(s) of white and shade 8 (i.e., 255−127=128; 128÷8=16). Thus, the RGB value calculated for shade 7 is (127+16,127+16,127+16)=(143,143,143), the RGB value calculated for shade 6 is (127+32,127+32,127+32)=(159,159,159), and so forth. Conversely, the RGB values for the shades that lie below shade 8 (shades 9 to 15 and black) represent eight different steps of equally-decreasing the RGB value(s) of shade 8 until the RGB value of black (i.e., RGB value of (0, 0, 0)) is reached. Accordingly, the lower eight different shades are calculated by subtracting multiples of “16” from each R, G and B value of shade 8, e.g., the RGB value calculated for shade 9 is (127−16,127−16,127−16)=(111,111,111), the RGB value calculated for shade 10 is (127−32,127−32,127−32)=(95,95,95), and so forth. In some embodiments, when the calculations described above produce non-integer numbers, the values can be rounded to the nearest integer value. In other embodiments, the non-integer numbers can be rounded down to the largest integer value.

Alternatively, in one embodiment, when a hue, saturation, and lightness (HSL) color scheme is implemented, the RGB value of shade 8 (i.e., (127,127,127)) is equivalent to an HSL value of (0,0,120), where the hue value has a range between 0 to 239, the saturation value has a range between 0 to 240, and the lightness value has a range between 0 to 240. If the HSL color scheme is implemented, the upper eight different shades are sequentially calculated by adding respective multiples of “15” to the lightness value, where “15” is derived from dividing by eight (different shades) the difference between the lightness value of white and shade 8 (i.e., 240−120).

In other embodiments, the values of the different shades in a palette can be calculated by extrapolating (x,y) coordinates over a color gradient plot, an illustration of which is included in FIG. 3B. As shown in FIG. 3B, a color for shade 8 is selected by a user at the (x,y) coordinates 390 from a color gradient plot 389. The color white appears at the upper-left corner of the color gradient plot 389. The color black appears along the lower edge of the color gradient plot 389. In one example, to calculate the color shades for the palette, a software application draws a first line from the color selected by the user to the upper-left corner of the color gradient plot 389, and draws a second line from the color selected by the user straight down to the lower edge of the color gradient plot 389. In other examples, the second line may be drawn from the color selected by the user to the lower-left corner of the color gradient plot 389 or to the lower-right corner of the color gradient plot 389. The shades for the palette are determined by hash marks on the first line and the second line.

As further shown in FIG. 3B, hash marks 391 on the first line correspond to the upper eight different shades included in generated palette 326, and hash marks 392 on the second line correspond to the lower eight different shades included in the generated palette 326. In this way, the colors in the palette 326 are assigned according to the color coordinates that correspond to the hash marks 391, 392 on the first and second lines.

One having ordinary skill in the art will recognize that any color scheme may be implemented by the embodiments described herein, such as the hue, saturation and value (HSV) color scheme, the cyan, magenta, yellow and black (CMYK) color scheme, and the like.

As described above, each of the UI elements included in user interface 300 is associated with a particular “shade” of color included in one of the background palette 302, the typography palette 304 or the accent palette 306. For example, as shown in FIG. 3A, a hierarchical navigation panel of user interface 300 (e.g., a panel having text that reads “Top Level>Sub Level 1>Sub Level 2”) is associated with shade “12” of typography palette 304, a top border and a bottom border of user interface 300 are each associated with shade 12 of accent palette 306, a header of user interface 300 is associated with shade 4 of background palette 302, a header link panel (“Link 1 Link 2 Link 3 Link 4”) of user interface 300 is associated with shade 13 of typography palette 304, a title heading of user interface 300 is associated with shade 9 of typography palette 304, a border for thumbnails in a thumbnail grid and for a main window of user interface 300 is associated with shade 8 of accent palette 306, a shadow of the main window is associated with shade 5 of accent palette 306, a body of user interface 300 is associated with shade 3 of background palette 302, a text block in the body of user interface 300 is associated with shade 11 of typography palette 304, and a footer of user interface 300 is associated with shade 5 of typography palette 304.

The association of a particular UI element to a particular shade in a particular color palette is defined according to a pre-determined mapping. In one embodiment, the pre-determined mapping is based on a color scheme that has been identified by an administrator as being pleasant to the human eye. In other embodiments, the user can select from a list of pre-determined mappings from UI elements to shades in a color palette or may define a customized mapping. Embodiments of the invention implement the pre-determined mapping according to a variety of techniques including, but not limited to, Cascading Style Sheets (CSS), JavaScript, XML files, server side scripting languages (such as PHP or Active Server Page (ASP.net) technologies), and the like. Also, according to various embodiments, the calculations of different shades included in the palettes may be executed by either one or more web servers 108, software(s) 104 executing on client computer 102 (such as the web browser that displaying to the user the user interface 300), or a combination thereof.

As described above, the illustrations in FIG. 3A depict various UI elements of user interface 300 that are displayed according to a shade of color included in a particular color palette. Oftentimes, a user desires to adjust the overall look and feel of user interface 300 in a simple manner. Accordingly, embodiments of the invention include techniques that allow the user to apply a color theme to user interface 300 by selecting one (or more) colors. In the example illustrated in FIG. 3A, the user initializes the selection of the one (or more) colors by clicking on the link 312 that reads “New! Create a color scheme for your page . . . ”, which is configured to redirect the user to a color palette generation interface 320, described below in conjunction with FIG. 3B.

The color palette generation interface 320 shown in FIG. 3B enables the user to select a color on which to base the contrasting color scheme, according to one embodiment. In one embodiment, the color palette generation interface 320 can be displayed in a separate pop-up window, as shown in FIG. 3B. There are several ways in which the user can select the single color from which the other colors in the palette 326 are determined. In one embodiment, the user may select a pre-defined color from a grid of colors in color picker 322. In another embodiment, color picker 324 enables the user to select the color from a color gradient and, if desired, fine-tune the color by adjusting the RGB values of the selected color. In still further embodiments (not shown), alternative color pickers or input interfaces (e.g., hexadecimal color values by number) for selecting a color may be presented to the user from which the user can select the color, e.g., HSL or HSV color schemes, and are also within the scope of embodiment of the invention. In the example shown, the user selects from color picker 322 or color picker 324 the color red, which has an RGB value of (255,0,0).

In one embodiment, a web server 108 receives the selection of the single color and assigns the selected color as shade 8 included in generated palette 326. Web server 108 then generates the shades that lie above (i.e., tending to white) and below (i.e., tending to black) shade 8 (shades 1 to 7, 9 to 15, white, and black) in the color palette 326 according to the techniques described above.

In some embodiments, a user can edit the range of the shades of the generated palette by selecting an edit range link 300, which causes an interface, such as the one portrayed in FIG. 3C, to be displayed. As shown in FIG. 3C, a palette shade distribution editor 328 is displayed and allows the user to redefine the values of the first and second termination colors for the palette based on a user previously selecting a color as the selected color for shade 8. As shown, the palette shade distribution editor 328 includes two sliders that may be used to set termination colors for the palette. In the example illustrated in FIG. 3C, the user has moved the sliders towards the center of the palette shade distribution editor 328 (i.e., away from “white” and “black”). The locations of the sliders correspond to the custom starting color and the custom ending color of the palette 326′. In turn, web server 108 modifies generated palette 326 and displays modified generated palette 326′. In the modified generated palette 326′, the difference between each shade is smaller than the difference between each shade in generated palette 326 (i.e., due to the termination colors set by the user being closer together that in the generated palette 326).

As illustrated in FIG. 3C, embodiments of the invention enable the user to modify the shades of color in the generated palette 326 by reassigning the selected color (e.g., shade 8) to a different position in the color palette. In one embodiment, double-clicking a shade of color (i.e., “Black”) causes that shade of color to be replaced by the shade of color selected by the user via the color picker 322 or the color picker 324. In the example illustrated in FIG. 3C, the user double-clicks the color “Black”, which is then replaced by the color red with an RGB value of (255, 255, 255). As a result, the generated palette 326 is processed according to the new custom end termination color to produce the generated palette 326″, which is also illustrated in FIG. 3C. In this way, the user is enabled to generate color palettes that include colors with only slight differences in shade, giving the color palette a pastel-like characteristic.

Furthermore, some embodiments are associated with a single termination color, not two termination colors. In these embodiments, the selected color is placed at the end of the color palette (i.e., as a pseudo-termination color) and the single termination color is located at the other end of the color palette. The software application is then configured to generate the remaining shades of color between the selected color and the single termination color, as described below.

Turning now to FIG. 3D, each of the background palette 302, the typography palette 304 and the accent palette 306 is configured as a copy of the generated palette 326. The example illustrated in FIG. 3D assumes that the user selects the color red from shade 8 (i.e., RGB value of (255,0,0)) via color picker 322 or color picker 324, and did not modify generated palette 326 to include custom termination color(s). As illustrated in FIG. 3D, the various UI elements included in modified user interface 300′ reflect different shades included in background palette 302, typography palette 304 and accent palette 306. As shown, the user has applied a complex and contrasting color scheme across the entire user interface 300 by selecting only a single color, i.e., the red color for shade 8 and the additional shades of color that are generated by a software application, which may be executed by one or more web servers 108.

In some cases, the user may wish to modify user interface 300′ to include colors that are different than the selected single color, e.g., a blue color scheme for the UI elements included in modified user interface 300′ that are related to typography. Thus, embodiments of the invention enable the user to click on the link 340 that reads “Edit . . . ” included in any of the background palette 302, typography palette 304 and accent palette 306, which displays to the user color palette generation interface 320 described above in conjunction with FIG. 3B. Continuing with the example of changing the palette related to typography, a reference to the specific palette that is being edited by the user, i.e., typography palette 304, is maintained by web server 108. In this way, when the user selects the link 332 that reads “Finished” included in generated palette 326, the configuration of generated palette 326 is copied to typography palette 304, but not the background palette 302 or the accent palette 306, thereby retaining the original configuration of background palette 302 and accent palette 306. An example of this technique is illustrated in FIG. 3E, which displays modified user interface 300″ after a user has selected blue (RGB value of (0,0,255)) for typography palette 304 and purple (RGB value of (128,0,12)) for accent palette 306, via color palette generation interface 320.

Additionally, in some embodiments, the user may desire to update the particular shade of color and/or palette to which one or more UI elements included in user interface 300 refer, an example of which is illustrated in FIG. 3F. In one embodiment, the user right-clicks on any of the UI elements included in user interface 300, e.g., the header, footer, or body of user interface 300. In the example in FIG. 3F, the user right-clicks on the body of user interface 300, which causes context menu 350 to be displayed. The user may then toggle through the different palettes that are available, e.g., background palette 302, typography palette 304, and accent palette 306, by selecting the left/right arrows 352 (e.g., via mouse clicks or the arrow keys on the keyboard). The user may also toggle through the different shades included in the selected palette by selecting the up/down arrows 354. Each toggle or arrows 352, 354 is captured and causes web server 108 to update the shade of the appropriate UI element, i.e., the body, which enables the user to easily narrow on the changes that he or she is looking to make.

Additionally, the user may also directly modify any shade of color included in a palette, e.g., shade 12 included in background palette 302. In one embodiment, the user double-clicks on the shade of color that he or she wishes to change, whereupon a color picker is displayed from which the user is able to select a replacement color. Any UI elements included in user interface 300 that refer to the updated shade of color are correspondingly updated to match the new shade selected by the user. For example, the body of the user interface 300 can be changed from referring to background palette shade 3 to accent palette shade 5.

Additionally, in some embodiments, as shown in FIG. 3G, the user is able to modify the overall brightness of a color palette, e.g., the typography palette 306, by clicking on the edit link 340 associated with the typography palette 304, which causes a typography palette brightness/contrast editor 394 to be displayed to the user. As shown in FIG. 3G, the user is permitted to sequentially change the brightness and/or contrast of the typography palette 302, via the sliders included in the typography palette brightness/contrast editor 394.

In the example illustrated in FIG. 3G, the user increases the brightness by a factor of two, which causes the shade number for each UI element included in user interface 300 that is associated with the typography palette 302 to be correspondingly decreased by two, since lower shades of color in each of the palettes 302, 304 and 306 are brighter than the higher shades of color included therein. The UI elements that are affected by the increased brightness are highlighted by the bolded text in FIG. 3G. For example, the “Nav Panel” UI element, which previously referred to shade 12 in the typography palette 306, now refers to shade 10 in the typography palette 306. The “Header Link” UI element, which previously referred to shade 13 in the typography palette 306, now refers to shade 11 in the typography palette 306. The “Title” UI element, which previously referred to shade 9 in the typography palette 306, now refers to shade 7 in the typography palette 306. Finally, the “Text Block”, which previously referred to shade 11 in the typography palette 306, now refers to shade 9 in the typography palette 306. In the event that a user increasing or decreasing the brightness causes the number of the shade of color with which a UI element is associated to exceed the boundaries of the shade numbers included in the typography palette 306 (i.e., shade 1 and shade 15), then the shade of color with which the UI is associated is “wrapped around” to keep the shade of color within the boundaries of the shade numbers included in the typography palette 306. For example, if a UI element is associated with shade 15 in the typography color palette 306 and the brightness is decreased by a factor of two, then the UI element is updated to be associated with shade 2, not “shade 17” in the typography color palette 306. Conversely, if a UI element is associated with shade 1 in the typography color palette 306 and the user increases the brightness by a factor of four, then the UI element is updated to be associated with shade 12, not “shade −3” in the typography color palette 306.

FIG. 3H illustrates the user modifying the overall contrast of the background color palette 302 (i.e., by clicking on the edit link 340 associated with the background color palette 302), which causes a background palette brightness/contrast editor 396 to be displayed to the user. As described above in conjunction with FIG. 3B, various (x,y) coordinates are plotted evenly over a color gradient plot 389. When the user adjusts the contrast of the background palette 302, each of the hash marks 391, 392 transition from being equally spaced apart to instead being spaced apart based on a non-linear curve. For example, increasing the contrast causes the hash marks 391, 391 closest to the (x,y) coordinate 390 to be spaced closer together, which is illustrated as the adjusted color palette 389′. Conversely, decreasing the contrast causes the coordinates closest to the hash marks 391, 392 to be spaced farther apart, which is illustrated as the adjusted color palette 389″. Each shade of color in the background palette 302 is then updated according to the color that lies beneath the corresponding hash mark.

In yet another embodiment, certain UI elements in the GUI may be linked so that the shade numbers of the UI elements maintain a certain distance relative to one another. For example, a first UI element may be associated with shade number “4” and a second UI element may be associated with shade number “8,” where the first UI element and the second UI element are linked. Linking of the first and second UI elements provides that the difference between the color shade numbers of the first and second UI elements is maintained, i.e., the difference is set to 8−4=4. Therefore, if the shade number associated with the second UI element is changed by the user to “7,” then the shade number of the first UI element is automatically changed to “3” to maintain the difference of 4. In addition, the difference is said to “wrap around” when the color shade numbers reach the end of the color palette. For example, if the shade number associated with the second UI element is changed by the user to “1,” then the shade number of the first UI element is automatically changed to “14.” Color shade “14” is 4 color shade units away from color shade “1” based on wrapping around to the other end of the color palette, thereby maintaining a difference of 4 color shade units.

FIGS. 3A-3H illustrate three different palettes that each include seventeen total shades of color. However, these illustrations are merely exemplary and do not limit the scope of embodiments of the invention. For example, any number of palettes that include any number of shades of colors may be associated with any number of UI elements included in user interface 300.

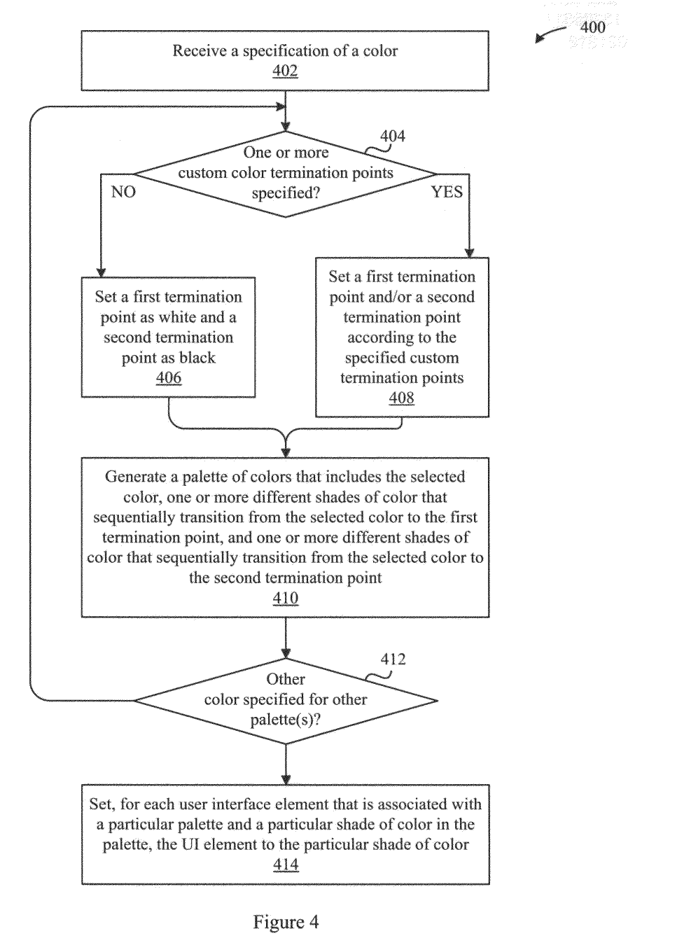

FIG. 4 is a flow diagram of method steps 400 for applying a color scheme to a user interface 300, according to one embodiment of the invention. Persons skilled in the art will understand that, even though method 400 is described in conjunction with FIGS. 1-3G, any system configured to perform the method steps, in any order, is within the scope of embodiments of the invention.

As shown, method 400 begins at step 402, where web server 108 receives a specification of a color. For example, the color may be specified by a user via color palette generation interface 320, described above in conjunction with FIG. 3B.

At step 404, web server 108 determines whether one or more custom color termination points are specified by the user. For example, according to the techniques described herein, custom color termination points may be specified via palette shade distribution editor 328 or by double-clicking a shade of color in the palette to set that shade of color equal to the specified color. If, at step 404, web server 108 determines that the user does not specify any custom color termination points, then method 400 proceeds to step 406, where web server 108 sets a first termination point as the color white and a second termination point as the color black. For example, white and black termination points may be defined by default. If, however, web server determines that the user specifies one or more custom color termination points, then method 400 proceeds to step 408, where web server 108 sets a first termination point and/or a second termination point according to the one or more custom termination points specified via palette shade distribution editor 328. In one embodiment, the selected color may be set as a first termination point and a default color, such as white or black, may be set as the second termination point.

At step 410, web server 108 generates a palette of colors, e.g., background palette 302, that includes the specified color from step 402 and one or more different shades of color that sequentially transition from the specified color to the first termination point, and one or more different shades of color that sequentially transition from the selected color to the second termination point, as described above in conjunction with FIG. 3B.

At step 412, web server 108 determines whether the user specifies another color for one or more other palettes, e.g., by selecting a different color for typography palette 304 and/or accent palette 306 than the color that was selected for the background palette 302 generated at step 410. If, at step 412, web server 108 determines that the user specifies another color for another palette, then the method steps 404-410 are repeated according to the techniques described above to define the colors for the other palette.

Otherwise, method 400 proceeds to step 414, where web server 108 sets, for each user interface element that is associated with a particular palette and a particular shade of color in the palette, the UI element to the particular shade of color, as described above in conjunction with FIGS. 3C, 3D and/or 3E.

Advantageously, embodiments of the invention provide an improved technique for generating and applying a color theme to a user interface. A color palette is generated according to a base color selected by a user and includes various shades of the color that range between two separate endpoint/termination colors, such as white and black. Various UI elements included in the user interface are each mapped to a shade of color included in the generated color palette, or to various shades of color included in one of additional color palettes with which the user interface is associated. The user may also assign colors to each of the additional color palettes (if included) to establish a contrasting color theme that includes two or more colors. Additionally, the user is able to modify both the color palette and/or the shade of color to which the various UI elements are mapped. As a result, the user is able to generate and apply a color theme to the user interface simply by selecting one base color. Moreover, the user is able to conveniently modify aspects of the contrasting color theme by selecting additional colors, setting endpoint colors, and assigning UI elements to different color palettes, and/or shades of color included therein.

While the forgoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

It will be appreciated to those skilled in the art that the preceding examples are exemplary and not limiting. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A method for applying a color scheme to a user interface that includes one or more user interface (UI) elements, the method comprising:
receiving a selection of a first color;
generating a first portion of a color palette that includes the first color and one or more colors that sequentially transition from the first color to a first termination color; and
assigning a color from the color palette to a UI element included in the user interface, wherein the color from the color palette corresponds to a position in the color palette associated with the UI element.

2. The method of claim 1, further comprising generating a second portion of the color palette that includes one or more colors that sequentially transition from the first color to a second termination color.

3. The method of claim 2, wherein generating the one or more colors that sequentially transition from the first color to the first termination color comprises adjusting color properties of each of the one or more colors, and generating the one or more colors that sequentially transition from the first color to the second termination color comprises adjusting color properties of each of the one or more colors.

4. The method of claim 2, wherein the first termination color comprises a first custom color specified by a user and the second termination color comprises a second custom color specified by the user.

5. The method of claim 2, wherein the first termination color is white and the second termination color is black.

6. The method of claim 1, wherein the first color is located at either a topmost position in the color palette or a bottommost position in the color palette and the first portion of the color palette includes all colors included in the color palette.

7. The method of claim 1, wherein the first color is located in the color palette at a position other than a center position, and the first portion of the color palette includes more than half of the colors in the color palette.

8. The method of claim 7, wherein a second portion of the color palette includes one or more colors in the color palette that sequentially transition from the first color to a second termination color, wherein the second portion of the color palette includes less than half of the colors in the color palette.

9. The method of claim 1, further comprising:
receiving a selection of a first UI element;
receiving a selection of a second position in the color palette other than a first position associated with the first color;
associating the first UI element to the first position in the color palette; and
assigning a second color to the first UI element that corresponds to the second position in the color palette.

10. The method of claim 1, further comprising:
receiving a selection of a second color;
generating a second color palette that includes the second color, one or more colors that sequentially transition from the second color to a first termination color, and one or more colors that sequentially transition from the second color to a second termination color; and
assigning a color from the second color palette to a second UI element included in the user interface, wherein the color from the second color palette corresponds to a position in the second color palette associated with the second UI element.

11. The method of claim 10, wherein the color palette is associated with background UI elements and the second color palette is associated with text and/or accent UI elements.

12. The method of claim 1, wherein the selection of the first color is received via a color palette UI.

13. A non-transitory computer-readable medium storing instructions that, when executed by a processor, cause a computer system to apply a color scheme to a user interface that includes one or more user interface (UI) elements, by performing the steps of:
receiving a selection of a first color;
generating a first portion of a color palette that includes the first color and one or more colors that sequentially transition from the first color to a first termination color; and
assigning a color from the color palette to a UI element included in the user interface, wherein the color from the color palette corresponds to a position in the color palette associated with the UI element.

14. The non-transitory computer-readable medium of claim 13, further comprising generating a second portion of the color palette that includes one or more colors that sequentially transition from the first color to a second termination color.

15. The non-transitory computer-readable medium of claim 14, wherein generating the one or more colors that sequentially transition from the first color to the first termination color comprises adjusting color properties of each of the one or more colors, and generating the one or more colors that sequentially transition from the first color to the second termination color comprises adjusting color properties of each of the one or more colors.

16. The non-transitory computer-readable medium of claim 14, wherein the first termination color comprises a first custom color specified by a user and the second termination color comprises a second custom color specified by the user.

17. The non-transitory computer-readable medium of claim 14, wherein the first termination color is white and the second termination color is black.

18. The non-transitory computer-readable medium of claim 13, wherein the first color is located at either a topmost position in the color palette or a bottommost position in the color palette and the first portion of the color palette includes all colors in the color palette.

19. The non-transitory computer-readable medium of claim 13, wherein the first color is located in the color palette at a position other than a center position, and the first portion of the color palette includes more than half of the colors in the color palette.

20. The non-transitory computer-readable medium of claim 19, wherein a second portion of the color palette includes one or more colors in the color palette that sequentially transition from the first color to a second termination color, wherein the second portion of the color palette includes less than half of the colors in the color palette.

21. The non-transitory computer-readable medium of claim 13, further comprising:
receiving a selection of a first UI element;
receiving a selection of a second position in the color palette other than a first position associated with the first color;
associating the first UI element to the first position in the color palette; and
assigning a second color to the first UI element that corresponds to the second position in the color palette.

22. The non-transitory computer-readable medium of claim 13, further comprising:
receiving a selection of a second color;
generating a second color palette that includes the second color, one or more colors that sequentially transition from the second color to a first termination color, and one or more colors that sequentially transition from the second color to a second termination color; and
assigning a color from the second color palette to a second UI element included in the user interface, wherein the color from the second color palette corresponds to a position in the second color palette associated with the second UI element.

23. The non-transitory computer-readable medium of claim 22, wherein the color palette is associated with background UI elements and the second color palette is associated with text and/or accent UI elements.

24. The non-transitory computer-readable medium of claim 13, wherein the selection of the first color is received via a color palette UI.

25. A computer system, comprising:
a processor; and
a memory storing instructions that, when executed by the processor, cause the computer system to apply a color scheme to a user interface that includes one or more user interface (UI) elements, by performing the steps of:
receiving a selection of a first color;
generating a first portion of a color palette that includes the first color and one or more colors that sequentially transition from the first color to a first termination color; and
assigning a color from the color palette to a UI element included in the user interface, wherein the color from the color palette corresponds to a position in the color palette associated with the UI element.

26. The system of claim 25, wherein the steps further include generating a second portion of the color palette that includes one or more colors that sequentially transition from the first color to a second termination color.
